(19) United States
(12) Patent Application Publication
(10) Pub. No.: US 2003/0091257 A1
(43) Pub. Date: May 15, 2003

(54) Optical waveguide devices and method of fabrication

(76) Inventors: Utpal Kumar Chakrabarti, Allentown, PA (US); Julia C. Duncan, Mertztown, PA (US); Kevin Cyrus Robinson, Zionsville, PA (US); Michael R. Serbin, Trexlertown, PA (US); Yiu-Man Wong, Wescosville, PA (US)

Correspondence Address: Docket Administrator, Agere Systems Inc., P.O. Box 614, Berkeley Heights, NJ, 07922-0614, US

(21) Appl. No.: 10/007,290

(22) Filed: Nov. 10, 2001

(51) Int. Cl. G02F 1/035; G02B 6/10

(52) U.S. Cl. 385/2; 385/131

(57) ABSTRACT

The invention is an optical waveguide device and method of fabrication, where the device includes a pyroelectric substrate such as lithium niobate, a waveguide formed in the substrate, a buffer layer formed over the substrate, and at least one electrode formed over the buffer layer. The device further includes a dielectric diffusion barrier layer formed between the substrate and the buffer layer. The dielectric material is preferably a fluorine-doped nitride or a deuterated nitride.

### FIELD OF THE INVENTION

This invention relates to optical waveguide devices, such as modulators, and in particular to waveguide modulators made from a pyroelectric crystal such as Lithium Niobate.

### BACKGROUND OF THE INVENTION

Lithium niobate waveguide modulators have become a key component in optical networks employed for telecommunications applications. These devices operate by applying an electrical bias to electrodes formed over the crystal surface while propagating an optical signal through a diffused waveguide at the surface. The device also typically includes a buffer oxide on the surface of the crystal to prevent the optical signal from being absorbed by the electrodes. The bias changes the index of refraction of the waveguide. In the case of electroabsorption modulators, a change in the absorption of the light is effected. In the case of Mach-Zehnder modulators, the phase of the light in one arm of the device is altered with respect to the phase in the other arm. Other types of devices such as high speed switches and attenuators can also be formed with such a structure.

One of the problems often experienced by such devices is bias voltage drift over a period of time. That is, the magnitude of the voltage required to produce a desired change in index of refraction can vary as the device operates, thus resulting in device instability. This drift is generally believed to be due to release of trapped mobile Li ions in the oxide which had out-diffused from the bulk of the substrate during a thermal annealing step.

It has been suggested to reduce this bias drift by including a Li ion blocking layer between the substrate and buffer layer. Suitable materials for this blocking layer include Si₃N₄, SiON, and MgF₂. (See U.S. Pat. No. 5,479,552 issued to Kitamura.) It has also been suggested to employ a lower conductance layer between the substrate and buffer layer, and a layer capable of trapping ions between the buffer layer and the electrodes. Suggested materials for the lower conductance layer are MgF₂, Si₃N₄, and Si, while a suggested material for the trapping layer is SiO₂ doped with phosphorous. (See Japanese Kokai Patent Application No. Hei 6(1994)-75195.)

While such approaches are adequate, there is a need in present and future systems for waveguide devices with enhanced stability for high process yields.

### SUMMARY OF THE INVENTION

The invention, in accordance with one aspect is an optical waveguide device which includes a pyroelectric substrate, a waveguide formed in the substrate, a buffer layer formed over the substrate, and at least one electrode formed over the buffer layer. The device further includes a dielectric layer formed between the substrate and the buffer layer where the dielectric layer comprises a material selected from a fluorine-doped nitride and deuterated nitride.

In accordance with another aspect, the invention is a method of forming an optical waveguide device comprising forming a waveguide in a pyroelectric substrate, forming a dielectric layer over the substrate where the layer is selected from a fluorine-doped nitride and deuterated nitride, and forming a buffer layer over the dielectric layer.

### BRIEF DESCRIPTION OF THE FIGURES

These and other features of the invention are delineated in detail in the following description. In the drawing:

FIG. 1 is an end view of an optical device in accordance with an embodiment of the invention;

FIG. 2 illustrates a SIMS profile of the device of FIG. 1 during a stage of fabrication in accordance with the same embodiment; and

FIGS. 3-8 are end views of the device of FIG. 1 during various stages of fabrication.

It will be appreciated, that, for purposes of illustration, these figures are not necessarily drawn to scale.

### DETAILED DESCRIPTION

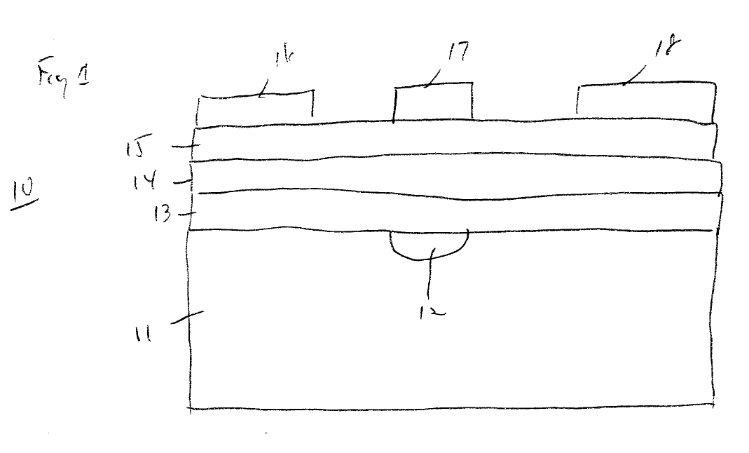

FIG. 1 is an end view of a typical optical device which may utilize the principles of the invention. The device, 10, is an optical modulator which includes a substrate, 11, comprising lithium niobate (LiNbO₃) or other pyroelectric material such as lithium tantalate (LiTaO₃). The substrate is typically approximately 1 mm thick and approximately 5×50 mm in size. An optical waveguide path, 12, is formed in the substrate, 11, usually by diffusion of titanium through a major surface.

Formed over part of or essentially the entire surface of the substrate, 11, is an insulating layer, 13, which, for reasons to be discussed, is a diffusion barrier layer, preferably a layer which comprises a fluorinated (fluorine-doped) nitride (SiₓF_{y}N_{z}:H) oxynitride or deuterated nitride (SiₓN_{y}:D) or oxynitride (SiₓO_{y}N_{z}:D). In the context of this application, a diffusion barrier layer is intended to include any dielectric layer that is a barrier to diffusion of lithium from the substrate. The layer also has an index of refraction less than that of the substrate to avoid optical losses. The thickness of the layer, 13, is preferably 0.1 to 0.4 microns. Formed over the insulating layer, 13, is another insulating layer, 14, which is known in the industry as a buffer layer. This layer is also a transparent dielectric layer having an index of refraction less than that of the substrate, and is typically silicon dioxide which is doped with In₂O₃ and TiO₂. In the context of this application, a buffer layer is intended to include any dielectric layer which prevents absorption of the optical signal by the electrodes. The thickness of layer 14 is usually in the range 0.6 to 1.2 microns. A charge dissipation layer, 15, is also preferably formed on the buffer layer, 15. The layer, 15, is typically TiₓSi_{y}N_{z} with a thickness of 0.6 to 1.2 microns. In the context of this application, a charge dissipation layer is intended to include any dielectric layer which allows pyroelectric charge in the substrate to be screened.

Electrodes, 16, 17, and 18, are deposited over the dissipation layer, 15. As known in the art, an electrical bias supplied to the electrodes varies the index of refraction of the waveguide path, 12, thereby modulating the intensity of any optical signal propagating through the path.

While not being bound by any theory, it is believed that one of the causes of bias voltage drift is the out-diffusion of Li from the substrate and the formation of Li-metal complexes in the doped buffer layer, 14. Over time and under bias, the lithium tends to dissociate from the complexes causing charge carrier accumulation and trapping near the interfaces between the electrode-buffer layer and waveguide-buffer layer. It is believed that this charge redistribution is responsible for voltage bias drift.

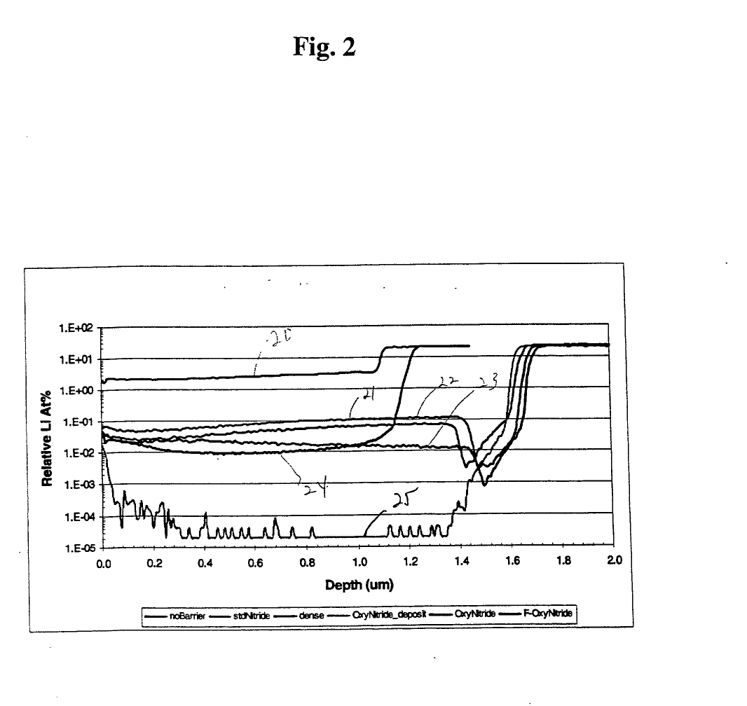

In order to alleviate this problem, layer 13 is chosen to be a material that blocks the diffusion of Lithium ions from the substrate. FIG. 2 shows the effectiveness of various layers in preventing the diffusion of lithium ions into the buffer layer, 14, during a post deposition thermal anneal. The figure is a SIMS profile of the relative lithium atomic percent as a function of depth from the top of the buffer layer (depth=zero) to the bottom surface of the substrate. Curve, 25, shows the profile prior to the annealing step when an oxynitride layer, 13, is also present. The top curve, 20, shows the profile in the absence of the layer, 13. Curve 21 shows the profile with the presence of a 300 nm thick layer of nitride between the buffer layer and substrate, curve 22 the profile with a 300 nm thick layer of dense nitride, and curve 23 the profile with the presence of a 300 nm thick layer of silicon oxynitride.

Curve 24 shows the profile in accordance with an embodiment of the invention where the layer, 13, comprises silicon oxynitride which has been doped with fluorine (Si_{w}FₓO_{y}N_{z}:H), and the thickness is approximately 0.3 microns. It will be noted that there is a significant amount of lithium in the buffer without the layer, 13 (curve 20) and the introduction of the diffusion barrier layer, 13, significantly reduces the amount of lithium. While the standard oxynitride (curve 23) reduces the amount of lithium by a factor of 100, the layer according to an embodiment of the invention (curve 24) reduces the amount of lithium by a factor of 200 throughout most of the dielectric layer 14. Thus, use of a fluorinated oxynitride provides significant improvement in stability over any previously suggested barrier layer of which applicants are aware.

FIGS. 3-8 show various stages of a typical fabrication sequence for producing the device of FIG. 1. It will be appreciated that, although a single device is shown, typically several devices will be formed from a single substrate.

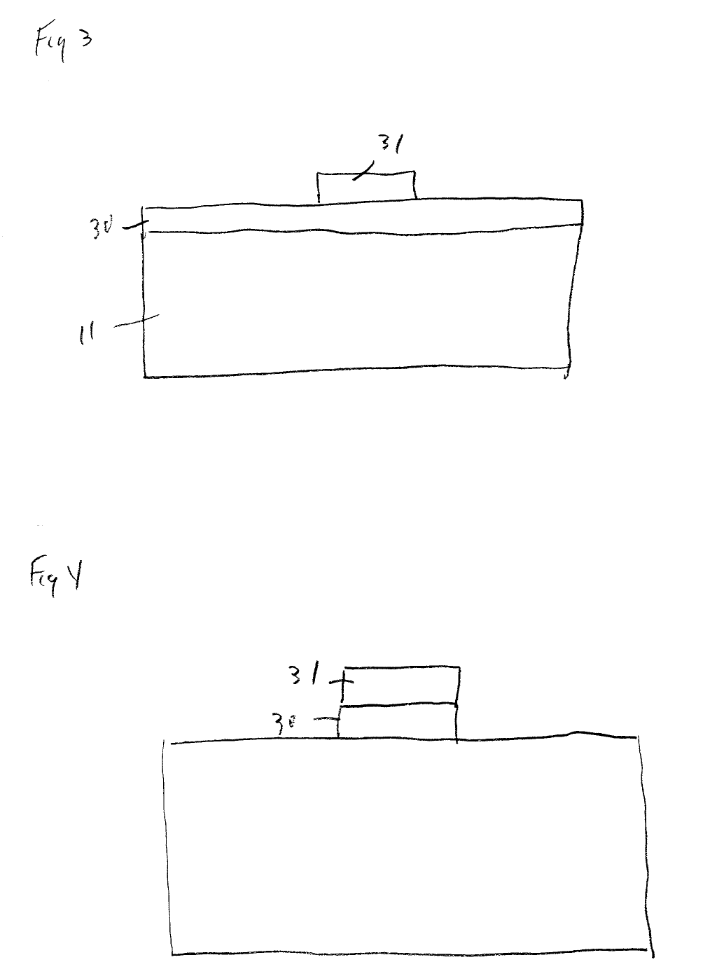

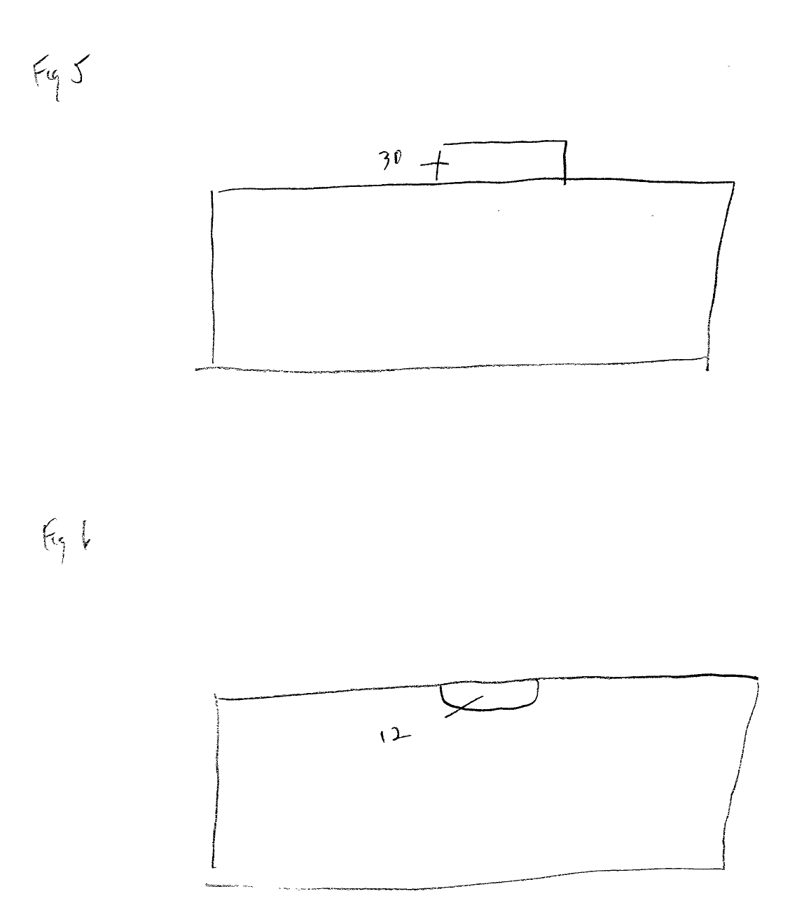

The processing starts with the lithium niobate substrate, 11, as shown in FIG. 3. As also shown in that figure, a layer, 30, of a metal such as titanium is deposited on a major surface of the substrate by standard techniques such as e-beam evaporation. A photoresist layer, 31, is deposited on the titanium layer and patterned by standard photolithographic techniques in order to expose the areas where titanium is not desired in the substrate. As illustrated in FIG. 4, the exposed titanium is etched away using the photoresist as a mask. This is followed by stripping away the remaining photoresist as shown in FIG. 5.

Next, as illustrated in FIG. 6, the remaining titanium is diffused into the substrate, 11, to form the waveguide path, 12. This diffusion is typically performed in air at a temperature of approximately 1000 deg C. for a time of approximately 12 hours.

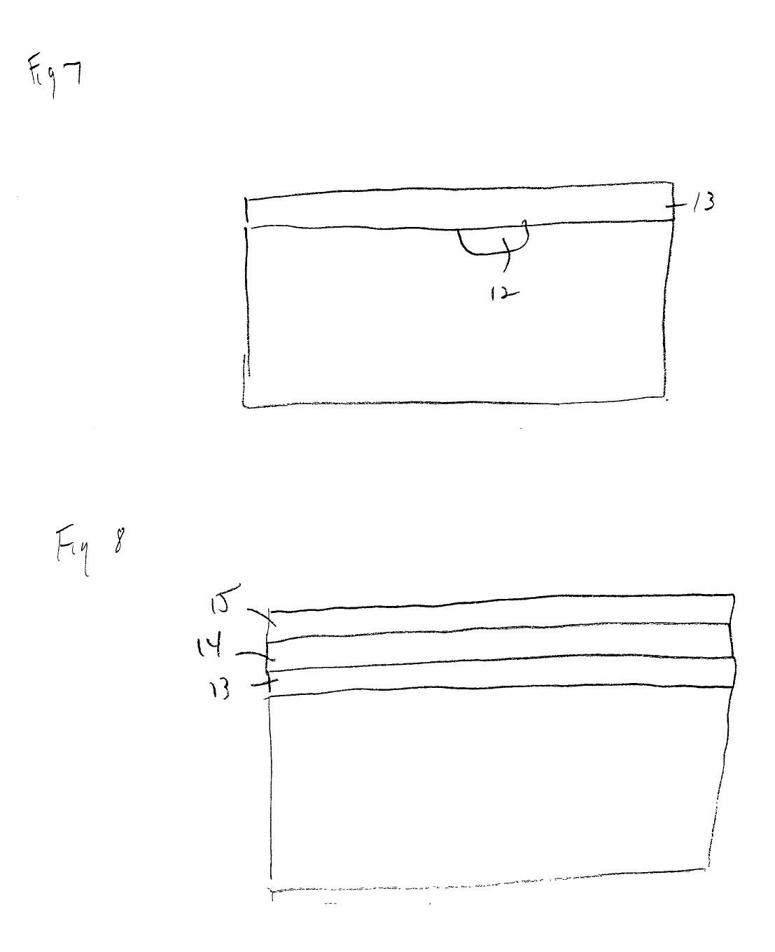

Next, as illustrated in FIG. 7, the barrier layer, 13, is deposited on the top surface of the substrate, 11. A preferred method of depositing the layer is plasma enhanced chemical vapor deposition (PECVD) where the gases employed are silane (SiH_{y}), ammonia (NH₃), nitrogen, helium, oxygen, and nitrogen trifluoride (NF₃). As previously discussed, the presently preferred composition is silicon oxynitride doped with fluorine (Si_{w}FₓO_{y}N_{z}:H). It may be desirable to grade the composition of the layer by intentionally varying the gas flow during deposition.

Then, as illustrated in FIG. 8, the buffer layer, 14, is deposited on the barrier layer 13. This is typically done by sputtering. This is followed by the deposition of the charge dissipation layer, 15, on the buffer layer, 14. The charge dissipation layer is typically also formed by sputtering.

One of the advantages of the use of layer 13 is that the need for careful control of In doping in the buffer layer, 14, is reduced due to the significant decrease of lithium ions in the buffer. This translates to a lower cost and a higher yield process.

In further processing, the electrodes, 16, 17, and 18, are deposited on the charge dissipation layer, 15, by standard techniques such as electroplating to give the structure shown in FIG. 1.

While fluorinated oxynitride is presently preferred for the barrier layer, 13, it is also expected that deuterated nitride (SiₓO_{y}N_{z}:D or SiₓN_{y}:D) will also be effective. Such a layer could be deposited by using deuterated silane (SiD_{y}) and/or deuterated ammonia (ND₃) instead of their isotopes in the PECVD process.

It should be understood that in the claims, a “nitride” is intended to broadly include an oxynitride as well as a pure nitride without oxygen.

What is claimed is:

1. An optical waveguide device comprising:
a pyroelectric substrate;
a waveguide formed in the substrate;
a buffer layer formed over the substrate;
at least one electrode formed over the buffer layer; and
a dielectric layer formed between the substrate and the buffer layer, where the layer comprises a material selected from a fluorine-doped nitride and deuterated nitride.

2. The device according to claim 1 wherein the dielectric layer comprises silicon oxynitride.

3. The device according to claim 1 wherein the dielectric layer has a thickness within the range 0.1 to 0.4 microns.

4. The device according to claim 1 wherein the device is an optical modulator.

5. The device according to claim 1 wherein the substrate comprises lithium niobate.

6. The device according to claim 1 wherein the dielectric layer has a graded composition.

7. The device according to claim 1 wherein the buffer layer comprises silicon dioxide which is doped with In₂O₃ and TiO₂.

8. The device according to claim 1 wherein the device further includes a charge dissipation layer comprising TiSiN.

9. An optical modulator comprising:
a substrate comprising lithium niobate;
a waveguide comprising titanium formed in the substrate;
a buffer layer comprising an oxide doped with In₂O₃ and TiO₂ formed over the substrate;
at least one electrode formed over the buffer layer;
a charge dissipation layer comprising TiSiN formed over the buffer layer; and
a dielectric layer comprising a material selected from the group consisting of a fluorinated oxynitride and a deuterated nitride formed between the substrate and the buffer layer.

10. A method of forming an optical waveguide device comprising:
forming a waveguide in a pyroelectric substrate;
forming a dielectric layer over the substrate where the layer comprises a material selected from a fluorine-doped nitride and deuterated nitride; and
forming a buffer layer over the dielectric layer

11. The method according to claim 10 wherein the dielectric layer is formed by plasma enhanced chemical vapor deposition.

12. The method according to claim 10 wherein the substrate comprises lithium niobate.

13. The method according to claim 10 wherein the buffer layer is formed by sputtering.

14. The method according to claim 10 wherein the waveguide is formed by diffusion of titanium into the substrate.

15. The method according to claim 10 further comprising forming a charge dissipation layer over the buffer layer by sputtering.

16. The method according to claim 10 wherein the dielectric layer composition is graded by altering gas flow during a plasma enhanced chemical vapor deposition.
